(19) United States
(12) Patent Application Publication
(10) Pub. No.: US 2004/0195866 A1
(43) Pub. Date: Oct. 7, 2004

(54) Modular vehicle roof with retractable roof rack

(76) Inventor: Enrico Fin, Lake Orion, MI (US)

Correspondence Address: CARLSON, GASKEY & OLDS, P.C., 400 WEST MAPLE ROAD, SUITE 350, BIRMINGHAM, MI, 48009, US

(21) Appl. No.: 10/791,429

(22) Filed: Mar. 2, 2004

Related U.S. Application Data
(60) Provisional application No. 60/459,486, filed on Apr. 1, 2003.

(51) Int. Cl. B62D 25/06

(52) U.S. Cl. 296/210

(57) ABSTRACT

A roof rack assembly includes a plurality of longitudinal and transverse elements mountable within the roof. The roof rack is pivotal between a stowed position and a deployed position. In the stowed position, the roof rack is received within recesses defined within a surface of the vehicle roof. In the deployed position, the roof rack is raised to support cargo above the surface of the modular roof. The longitudinal and transverse elements of the roof rack form a portion of the vehicle roof surface when in the stowed position. The shape of the longitudinal and transverse elements conform to the surface of the roof to provide a substantially continuous surface when in the stowed position.

### This application claims priority to U.S. application serial No. 60/459,486 filed Apr. 1, 2003.

### BACKGROUND OF THE INVENTION

This invention relates to a vehicle roof rack assembly for a motor vehicle and specifically to a modular roof having a retractable roof rack assembly.

Modular vehicle components are increasingly being used by vehicle manufactures to decrease vehicle assembly costs and improve production efficiency. Components are pre-assembled and shipped to a vehicle assembly area complete and ready for installation to a vehicle. One such modular component is a roof module. Roof modules may include components such as an interior headliner, sunroof assembly, interior mounted displays and other desired external and internal roof mounted features. One feature commonly assembled to an automotive roof is a roof rack for supporting cargo.

A roof rack is used to carry cargo that cannot be transported within the vehicle. Generally, roof racks include a load bearing structure formed by a series of rods or beams that are supported above a roof surface. In some instances the roof rack may disrupt and degrade aerodynamic characteristics which can adversely affect mileage performance of the vehicle.

Collapsible roof racks are an alternative to the fixed roof rack and typically collapsible onto the roof surface to present a less obtrusive profile. Collapsing the roof rack to the top surface of the vehicle roof does not completely remove the roof rack from view and therefore still affects the look and performance of the vehicle.

Another known roof rack configuration collapses entirely into a recess formed within the roof. The recess is necessarily large and takes up precious interior cabin space. As appreciated, vehicle manufactures are hesitant to reduce interior cabin space for exterior features. Further, the large cavity for the roof rack accumulates debris such as leaves, snow and ice that can cause difficulties in raising or lowering the roof rack.

Accordingly, for these reasons it is desirable to develop and design a modular roof including a roof rack assembly that does not adversely affect styling and vehicle performance.

### SUMMARY OF THE INVENTION

This invention is a modular roof having a roof rack assembly pivotal between a stowed position and a deployed position.

The roof rack assembly includes a plurality of longitudinal and transverse elements supported on pivotal support beams mountable within the roof. The roof rack is movable between a stowed position where the roof rack assembly is substantially flush with a surface of the vehicle roof, and a deployed position where the roof rack is spaced apart from the surface of the vehicle roof.

The longitudinal and transverse elements of the roof rack form a portion of the vehicle I roof surface when in the stowed position. The shapes of the longitudinal and transverse elements conform to the surface of the roof to provide a substantially continuous surface when in the stowed position. Because elements of the roof rack conform to the surface of the vehicle roof, aerodynamic and styling properties are substantially unaffected. Further, as the roof rack forms a portion of the roof surface, the roof module does not require a deep cavity for stowing the retracted roof rack.

Accordingly, the modular roof assembly of this invention provides a roof rack assembly that does not adversely affect styling and vehicle performance.

The various features and advantages of this invention will become apparent to those skilled in the art from the following detailed description of the currently preferred embodiment and the drawings that accompany the detailed description that are briefly described below.

### BRIEF DESCRIPTION OF THE DRAWINGS

FIG. 1 is a schematic view of a module vehicle roof including a collapsible roof rack in a deployed position.

FIG. 2 is a schematic view of the roof rack in a deployed position.

FIG. 3 is a schematic view of the roof rack in a stowed position.

FIG. 4 is a cross-section view of a portion of the roof rack in the deployed position.

FIG. 5 is a cross-sectional view of a portion of the roof rack in a stowed position.

FIG. 6 is a perspective view of the roof surface and a roof rack element.

### DETAILED DESCRIPTION OF THE PREFERRED EMBODIMENT

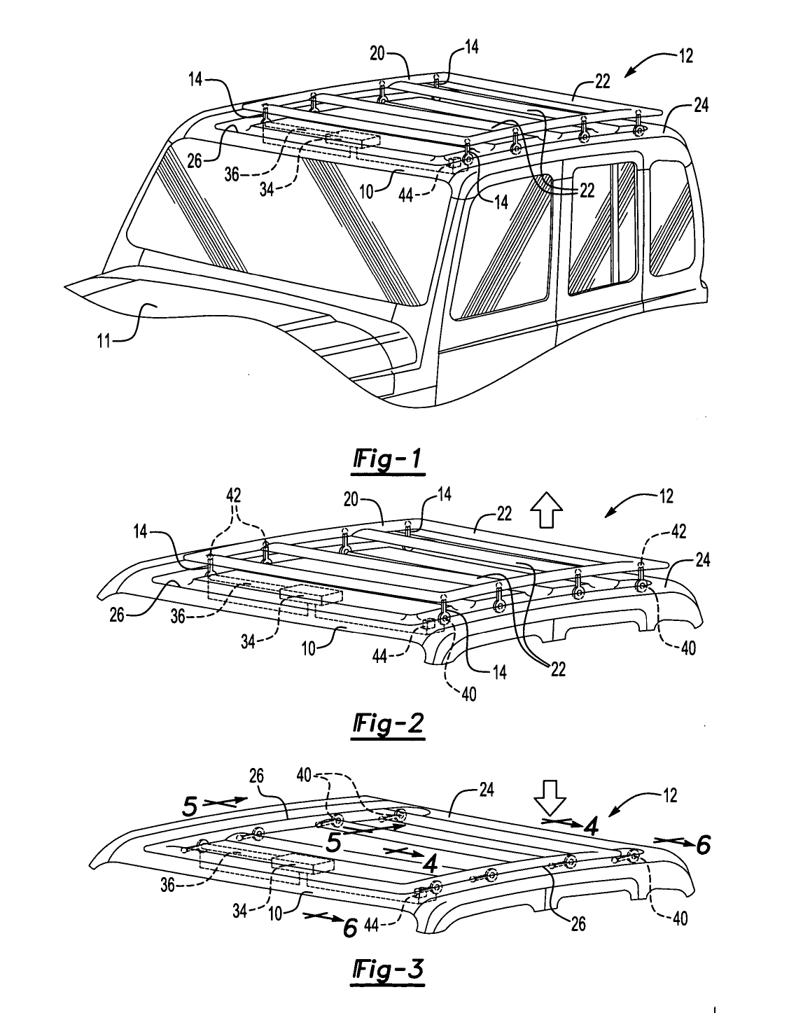

Referring to FIG. 1, a roof module 10 is mounted to a vehicle 11 and includes a retractable roof rack assembly 12. The roof rack assembly 12 includes a plurality of support members 14. Each support member 14 is pivotally attached to the roof module 10. The support members 14 are relatively short and pivot between a stowed position (FIG. 3) and a deployed position (FIGS. 1 and 2).

The roof rack assembly 12 includes at least one longitudinal member 20. Preferably, at least two longitudinal members 20 are provided, one on each lateral side of the roof module 10. Each support member 14 supports at least one cross member 22. The cross members 22 join the support members 14 to provide additional support for cargo.

The roof rack assembly 12 shown in FIG. 1 is in a deployed position. In the deployed position, cargo is supported above a roof surface 24. The retractable roof rack assembly 12 is stowable at least partially within recesses 26 that conform to the shape of the support members 14, cross members 22 and longitudinal members 20. The recess 26 includes a shape and depth that provide for substantially all of the roof rack assembly 12 to fold below or flush with the roof surface 24 when in the stowed position. In the stowed position the roof rack assembly 12 has a minimal affect on vehicle aerodynamic characteristics.

Referring to FIG. 2, the roof module 10 is shown with the roof rack assembly 12 in the deployed position where the longitudinal members 20 and cross members 22 are spaced apart from the roof surface 24. The support members 14 are rotated upward and extend from the roof surface 24.

An electric motor 34, rotates a bar 36. The bar 36 is attached to at least one support beam 14 disposed on either side of the roof module 11. A single motor 34 rotates the entire roof rack assembly 10 between the deployed and stowed positions. It is within the contemplation of this invention to provide additional drive assemblies to rotate the roof rack assembly 10 from the deployed or stowed positions.

Although an electrical motor is disclosed for moving the retractable roof assembly 12 between a deployed and stowed position it is within the contemplation of this invention to provide mechanical devices to raise and lower the roof rack assembly 12 manually.

The roof rack assembly 12 of this invention includes a latch 44 (shown schematically) that locks the roof rack assembly 12 in position. The latch 44 can be of any conventional arrangement known to a worker skilled in the art. The latch 44 provides for the use of the motor 34 only to raise and lower the roof rack assembly 12. The motor 34 is not utilized to maintain the position of the roof rack assembly 12 and therefore provides for the use of a substantially low powered motor to raise and lower the retractable roof assembly 12. Without a latch 44 the motor 34 would be required to be of sufficient power to raise and lower the roof rack assembly 12 and to maintain position of the retractable roof rack assembly 12 when in the deployed position full load of cargo.

Referring to FIG. 3, the roof rack assembly 12 is shown in the stowed position where the roof rack members 14, 22, 20 are substantially disposed within recesses 26. A portion of the roof rack members 14, 22, 20 extend upward and out of the recesses 26 to form a portion of the roof surface 24. The roof rack assembly 12 is preferably movable from the stowed position to the deployed position by pivoting about pivotal connections 40 mounted within the roof module 10. Each support member 14 also includes an upper pivotal connection 42 for attaching and providing relative movement between the cross members 22 and longitudinal members 20. A worker skilled in the art with the benefit of this disclosure will recognize that any pivotal connection known in the art is within the contemplation of this invention.

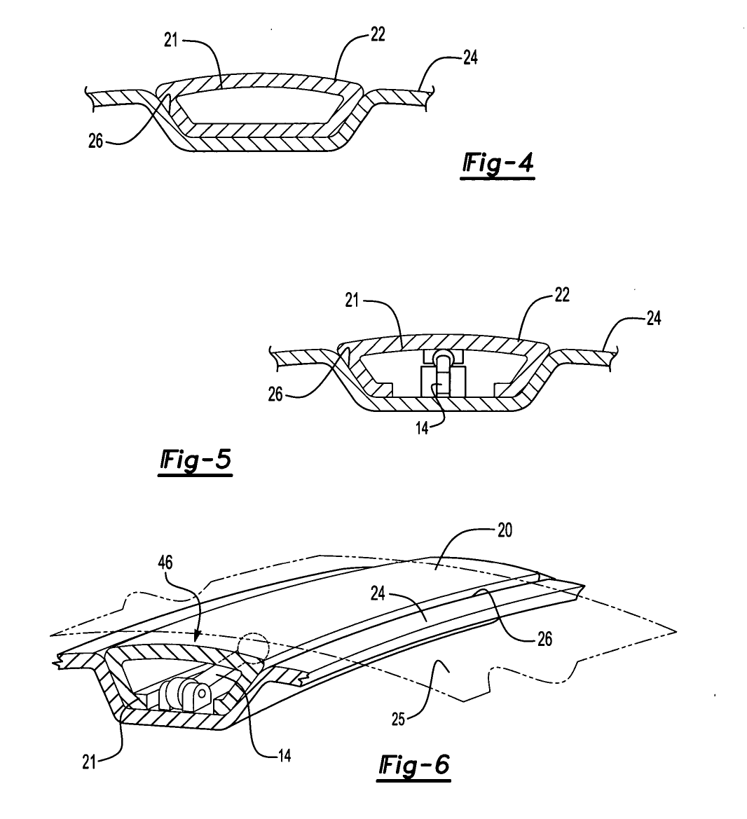

Referring to FIG. 4, a cross-section of the roof rack assembly 12 is shown in the stowed position. The recess 26 corresponds to the shape of the members 14,22, and 20 of the retractable roof rack 12. Further, a top surface 46 of each of the members 14,20,22 correspond to the roof surface 24 such that the retractable roof rack assembly 12 forms a substantially integral and continuous surface with the roof surface 24. Therefore in the stowed position, the members 14,20,22 and the vehicle roof surface 24 provides a continuous uninterrupted surface.

Referring to FIG. 5, a cross-section view of the longitudinal member 20 is shown in the deployed position. In the deployed position, the longitudinal member 20 is spaced a distance apart from the roof surface 24. The recess 26 comprises a smooth transition from the roof surface 24 down into the recess 26 and back out to the roof surface 24.

Referring to FIGS. 4 and 5, the shape of the rail members 14, 20 and 22 includes an oval cross-section 21 that is substantially absent of any flat surfaces that would extend perpendicular to airflow over the vehicle 11. In this way, even in the deployed position, the roof rack assembly 12 of this invention provides a substantially reduced amount of aerodynamic interference. Further, the oval cross-section 21 also allows for a substantially shallow recess 26 in which to stow the members 14,20, and 22.

The recesses 26 provide a shallow profile that inhibits accumulation of contaminants. In addition, the low shallow recess profile provides an easily cleanable surface due to its continuous transition from the roof surface 24 to the recess 26. The transition from the roof surface 24 to the recess 26 for storage of the retractable members 14,20, and 22 is such that there are no sharp profile changes that would be conducive to the accumulation of debris and contaminants.

Referring to FIG. 6, a longitudinal member 20 is shown forming a portion of the roof surface 24. The longitudinal member 20 includes a top surface 46 that blends into the roof surface 24 when in the stowed position. A plane 25 defined by the roof surface 24 extends across the recess 26. Preferably the top surface 46 of the longitudinal member 20 is disposed within the plane 25 when stowed. Further, the top surface 46 of the longitudinal member 20 may extend above the plane 25, but because of the oval shape cross-section 21 still form a continuous uninterrupted surface.

The roof module 10 of this invention provides an integrated assembly ready for installation to a motor vehicle. The retractable roof rack is received in to correspondingly shaped recesses to form a continuous surface that substantially reduces aerodynamic interference.

The foregoing description is exemplary and not just a material specification. The invention has been described in an illustrative manner, and should be understood that the terminology used is intended to be in the nature of words of description rather than of limitation. Many modifications and variations of the present invention are possible in light of the above teachings. The preferred embodiments of this invention have been disclosed, however, one of ordinary skill in the art would recognize that certain modifications are within the scope of this invention. It is understood that within the scope of the appended claims, the invention may be practiced otherwise than as specifically described. For that reason the following claims should be studied to determine the true scope and content of this invention.

What is claimed is:

1. A roof rack assembly for a vehicle comprising:
a plurality of rack elements movable between a stowed position where at least a portion of said rack elements are disposed below a plane defined by a roof surface, and a deployed position where said rack elements are spaced away from said plane.

2. The assembly as recited in claim 1, comprising a plurality of recesses within said roof surface for receiving said rack elements.

3. The assembly as recited in claim 2, wherein said recesses are formed as a continuous portion of said roof surface.

4. The assembly as recited in claim 3, wherein a portion of said recesses are disposed below said plane.

5. The assembly as recited in claim 3, wherein said rack elements are stowable at least partially within said recesses with a portion of said rack elements are disposed below said plane.

6. The assembly as recited in claim 3, wherein a portion of said rack elements comprise a portion of said roof surface.

7. The assembly as recited in claim 1, wherein said rack elements comprise a generally oval shape.

8. The assembly as recited in claim 1, wherein said rack elements comprise lateral and longitudinal elements.

9. The assembly as recited in claim 1, comprising a drive for moving said rack elements between said stowed and deployed positions.

10. A roof module assembly for a vehicle comprising:
a roof surface that defines a plane and a plurality of recesses disposed below said plane; and
a corresponding plurality of rack elements movable between a stowed position wherein said rack elements are at least partially received within said plurality of recesses and a deployed position spaced apart from said roof surface.

11. The assembly as recited in claim 10, wherein a portion of said rack elements are received within said recess and another portion is disposed at least partially above said plane.

12. The assembly as recited in claim 11, wherein said portion of said recess below said plane comprises an uninterrupted transition with said roof surface.

13. The assembly as recited in claim 10, wherein said rack elements form a portion of said surface of said roof assembly.

14. The assembly as recited in claim 10, wherein said rack elements comprise longitudinal and lateral members.

15. The assembly as recited in claim 10, comprising a drive for moving said rack elements between stowed and deployed positions.

16. The assembly as recited in claim 10, wherein said rack elements comprise an oval cross-section, and said recesses comprise a corresponding oval shape.

17. A roof rack assembly for a vehicle comprising:
a plurality of rack elements movable between a stowed position where at least a portion of said rack elements are disposed below a surface of a vehicle roof, and a deployed position where said rack elements are spaced apart from the surface of the vehicle roof; and
said rack elements comprising an oval cross-section.

18. The assembly as recited in claim 17, comprising an electric motor driving said rack elements between said stowed and deployed positions.

19. The assembly as recited in claim 17, wherein said rack elements provide a continuous surface corresponding with the vehicle roof when in said stowed position.
